(19) United States
(12) Patent Application Publication
(10) Pub. No.: US 2002/0030119 A1
(43) Pub. Date: Mar. 14, 2002

(54) Sprayer device, in particular for agricultural use

(76) Inventor: Rene Proharam, Plaisance du Touch (FR)

Correspondence Address: YOUNG & THOMPSON, 745 SOUTH 23RD STREET 2ND FLOOR, ARLINGTON, VA, 22202

(21) Appl. No.: 09/942,653

(22) Filed: Aug. 31, 2001

(30) Foreign Application Priority Data
Sep. 1, 2000 (FR) 00 11180

(51) Int. Cl. B05B 1/20

(52) U.S. Cl. 239/168; 239/159

(57) ABSTRACT

A sprayer device includes a main tank (2) for a carrier product, at least one tank (4, 8) for a chemical product intended to be mixed with the carrier product, a sprayer manifold (12) or the like and a pump (10) downstream of the main tank (2) for feeding the carrier product under pressure from the main tank to the sprayer manifold or the like.

Means (34) are provided to create a calibrated pressure drop between the outlet of the main tank (2) for a carrier product and the inlet of the pump (10).

Each tank (4, 8) for a chemical product is connected to an injection line (18) between the main tank (2) for a carrier product and the pump (10) by means (38, 42) enabling injection into that line of the chemical product in the corresponding chemical product tank.

The present invention relates to a sprayer device, in particular for agricultural use.

Using a sprayer mounted on the back of a tractor to treat crops is known in the art. This kind of sprayer includes a tank and a sprayer manifold. A pump is used to pressurize the product leaving the tank and to feed it to the sprayer manifold.

The tank usually contains water in which concentrated chemical products are diluted. This has a number of drawbacks. If the content of the tank is not used up completely when spraying, the tank must be emptied, which requires a special procedure because the products used cannot be introduced into the drainage system. This procedure is complicated and wastes the product that was in the tank and was not used. Also, before using the tank again, it must be cleaned in accordance with applicable European standards. Once again, cleaning must be carried out in accordance with a special procedure, which entails treating the rinsing water.

Conventional sprayers do not provide the facility to change product, inhibit a product or add a new product when the mixture has been prepared in the tank. It is therefore necessary to know the precise application for which the product placed in the tank is to be used at the time of filling the tank.

Direct injection systems that remedy some of the above drawbacks are already known in the art. They have a tank for water together with much smaller tanks for concentrated chemical products. Water is then pumped into the large tank and the products necessary for the intended treatment are injected under pressure into the pipe between the pump and the sprayer ramp by means of pumps. The document WO-97/02898 discloses one such device, which has the drawback of being difficult to fit to an existing sprayer and uses complex techniques based on metering devices consisting of diaphragm pumps associated with control and regulation electronics.

A direct injection system integrating metering pumps located downstream of the main pump of the sprayer and operating by virtue of the pressure provided by the pump is also known in the art. This solution is unreliable and is difficult to adapt to all kinds of sprayer. Also, it offers no flexibility of use and cannot be reliably automated so that the quantity of product to be metered can be programmed remotely.

Another drawback of prior art direct injection sprayer systems is their high head losses between the pump and the sprayer manifold. Accordingly, to obtain an acceptable pressure at the sprayer manifold, it is not possible to meter a large number of products. In practice, the number of products is generally limited to two.

It is difficult to meter products in these systems if low flow rates are required. In this case the pressure of the metering pump is not constant and it is then difficult to regulate the flow rate.

The document WO-99/39834 describes a sprayer device in which a chemical product (or several chemical products) is (or are) injected into a spray slurry. This device includes a pump having an inlet orifice and an outlet orifice and a looped pipe connecting the pump inlet to its outlet. A venturi system feeds the chemical product into the spray slurry in the loop.

The prior art sprayers referred to above are usually complex and rinsing the pipes is a lengthy and complicated process. These devices therefore have long maintenance times. Also, it takes a very long time to install and adjust the sprayer.

Another drawback of the above prior art systems is that their pumps or venturis cannot inject very viscous products. If such products must be sprayed, they are mixed directly in the water tank, which leads to the problems referred to above.

Thus an object of the present invention is to provide a sprayer whose design is as simple as possible and enabling metering of chemical products without polluting the carrier product, which is generally water. The sprayer advantageously also allows the use of viscous products without them having to be mixed directly in the main tank. The sprayer is preferably also able to meter the chemical product accurately.

To this end, the present invention proposes a sprayer device including a main tank for a carrier product, at least one tank for a chemical product intended to be mixed with the carrier product, a sprayer manifold or the like and a pump downstream of the main tank for feeding the carrier product under pressure from the main tank to the sprayer manifold or the like.

According to the invention, means are provided to create a calibrated pressure drop between the outlet of the main tank for a carrier product and the inlet of the pump and each tank for a chemical product is connected to an injection line between the main tank for a carrier product and the pump by means enabling injection into that line of the chemical product in the corresponding chemical product tank.

In this way, the chemical product(s) to be metered are metered by means of a pressure drop. The product is aspirated into the injection line and there is no utility in providing a supplementary pump for injecting the product into a pipe in which a carrier product (fluid) flows.

The pressure drop that is created is calibrated. The pressure drop is not necessarily fixed, but is known at all times, for example as a function of the flow rate of the carrier fluid.

The means for creating a pressure drop include a check valve, for example, but any other means of creating a pressure drop can be used.

In the sprayer device according to the invention, the means for injecting the chemical product into the injection line have an outlet from which the pure chemical product exits intermittently. In this way, the chemical product to be sprayed can be metered accurately.

In one embodiment, the sprayer device includes a hydraulic network having two parallel branches between the main tank for a carrier product and the pump, a first branch incorporating the means for creating the calibrated pressure drop and the second branch being the injection line.

In this case, the downstream end of the injection line is connected to the downstream end of the first branch by two injectors in parallel, one injector having a calibrated orifice. It is then possible to calculate continuously the opening time of the product injectors and to take into account the changing viscosity of the products to be sprayed.

A preferred embodiment of a sprayer device according to the invention includes a hydraulic network having two parallel branches between the main tank for a carrier product and the pump, the first branch incorporates the means for creating the calibrated pressure drop, the means for injecting the chemical product each take the form of a valve with two inlets and one outlet, one inlet of each valve is connected to the upstream point of the second branch, the second inlet of each valve is connected to a corresponding tank for a chemical product, the outlet of each valve is connected to the downstream point of the second branch, and the valve passes either the carrier fluid or the chemical product without mixing those products.

The sprayer device preferably includes an integral rinsing device including a rinsing tank provided with a rinsing valve and connected downstream of the pump, between it and the sprayer manifold, on the one hand, to each tank for a chemical product and, on the other hand, to the injection line via an injector.

At least one static homogenizer is advantageously provided downstream of the pump to guarantee good mixing of the sprayed solution.

A flowmeter can be provided at the outlet of the main tank to determine the flow rate of the carrier product.

The injection line is advantageously fitted with a pressure sensor to determine the flow rate of the injected chemical products more accurately. The injection line is preferably inclined to the horizontal.

To control the sprayer device, the means for injecting chemical product into the injection line and any sensors and valves are connected to an electronic module, for example, which controls the opening and closing of the injector means and any valves as a function of information received, on the one hand, by any sensors and, on the other hand, by a user.

The features and advantages of the invention will emerge further from the following description, which is given by way of example and with reference to the accompanying diagrammatic drawings, in which:

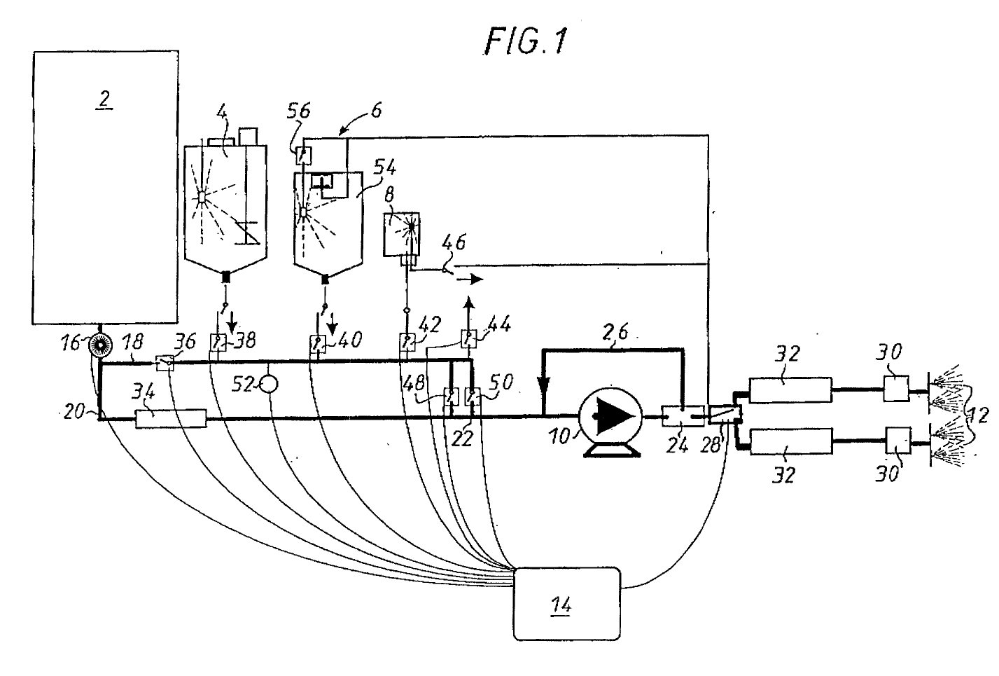

FIG. 1 shows diagrammatically a first embodiment of a sprayer according to the invention, and

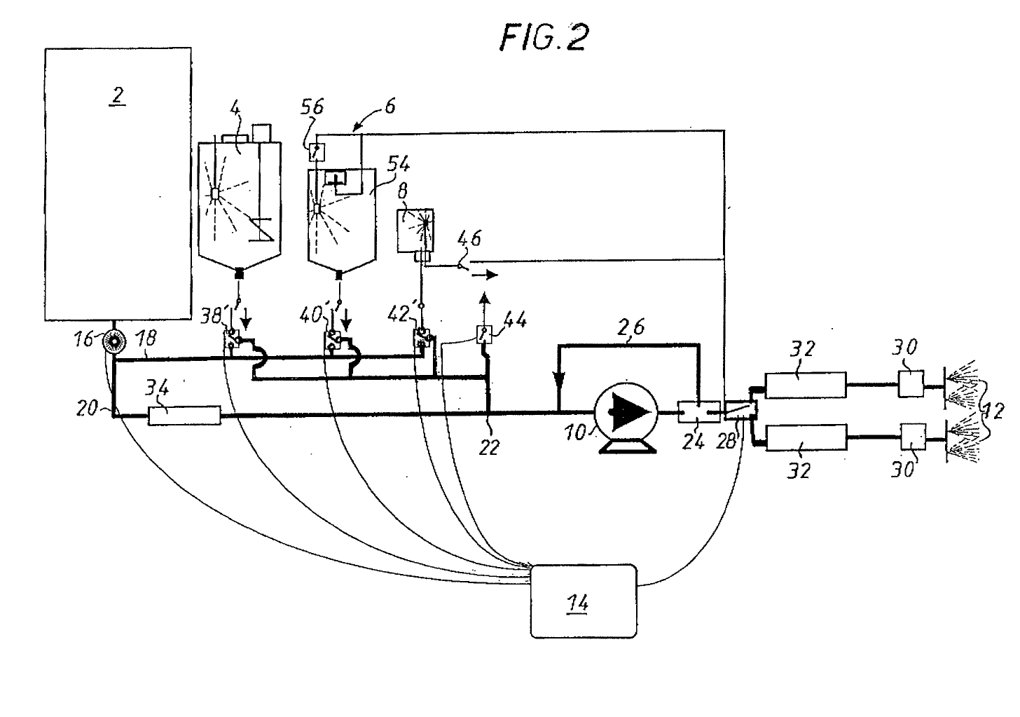

FIG. 2 shows a variant of the sprayer shown in FIG. 1.

FIG. 1 shows a main tank 2, a secondary tank 4, a rinsing device 6, packaging 8 containing a chemical product to be sprayed, a pump 10 and a sprayer manifold 12. An electronic module 14 for controlling the sprayer is shown diagrammatically in the figure.

There is a flowmeter 16 immediately downstream of the main tank 2. The main tank is intended to be filled with a carrier fluid, which is usually water. It will be assumed in the remainder of the description that the fluid is water. The flowmeter 16 determines the quantity of water consumed. It is optional and consideration may be given to locating it at some other place on the sprayer, for example upstream of the sprayer manifold 12. In the latter case, the flowmeter determines the quantity of solution sprayed. If the quantity of product injected into the water is known, determining the quantity of water consumed or the quantity of solution sprayed amount to the same thing.

Downstream of the flowmeter 16, the hydraulic circuit of the sprayer shown in the drawing includes a branch connection downstream of which are two branches. A first branch is referred to hereinafter as the injection line 18 and the second branch is referred to hereinafter as the head loss line 20. The injection line 18 and the head loss line 20 are joined together at a point 22 which is the downstream junction point of the lines 18 and 20. This junction point is upstream of the pump 10. The injection line 18 is preferably inclined to the horizontal.

Downstream of the pump 10 is a pressure regulator 24 which feeds the solution pumped by the pump 10 either to the sprayer ramp 12 or into a return pipe 26 which can feed a portion of the pumped solution upstream of the pump 10, between the latter's inlet and the junction point 22.

Downstream of the pressure regulator device 24, in the direction toward the sprayer manifold 12, is a switch 28 for feeding the solution either into the whole of the sprayer manifold 12 or into only one manifold section 30. There is a respective static homogenizer device 32 upstream of each manifold section 30 and downstream of the switch 28.

On the head loss line 20 there is only a load for creating a calibrated pressure drop of the order of a few tenths of a bar between the outlet of the main tank 2 and the inlet of the pump 10. The load consists of a check valve 34, for example, but can also be a nozzle, a filter or some other device. The pressure drop created is not necessarily constant, but its variations are known, for example as a function of the flow rate measured by the flowmeter 16.

In this way, a calibrated pressure drop is created between the flowmeter 16 and the pump 10. It is also present in the injection line 18. At the inlet of the injection line 18, i.e. at the same end thereof as the flowmeter 16, there is firstly an injector 36 for water from the tank 2. Four injectors 38, 40, 42 and 44 are connected to the injection line 18 downstream of the injector 36.

The number of injectors on the injection line determines the number of separate products that can be injected into the water flowing between the main tank 2 and the sprayer manifold 12.

In FIG. 1, the first injector 38 after the water injector 36 injects the phytosanitary product in the secondary tank 4 into the injection line 18. The tank 4 is a conventional tank as currently used on direct injection sprayer systems. This kind of tank is well known to the skilled person and is therefore not described in detail here.

The second injector 40 is connected to the rinsing device 6, whose operation is described later.

The third injector 42 is connected to the packaging 8. This is the original packaging of a concentrated phytosanitary product. A stopper with two outlets means that the user does not need to come into contact with the product contained in the packaging 8. The stopper includes a quick-release device with a valve enabling the concentrated product packaging to be positioned with the stopper at the bottom during spraying. This avoids problems due to shaking and enables the packaging 8 to be emptied completely.

The stopper is a conical stopper to which is fixed a seal resistant to the product contained in the packaging 8 and providing a seal. The stopper is secured to the packaging 8 by an elastic strap, for example, or an adjustable strap hooking onto two lugs at the top of the stopper. A quick-release coupler for aspirating the product, and which incorporates a valve, and a tube extending to the bottom of the canister pass through the stopper. The tube extending to the bottom of the canister has at the top a nozzle rotatable through 360° for entry of air during spraying and when rinsing the packaging 8 with clean water at the end of spraying. The outside end of this pipe can terminate in a quick-release coupler 46 for connecting the rinsing water feed.

The fourth injector 44 enables air at atmospheric pressure to enter the injection line 18.

Each of the injectors 36 to 44 is either completely open or completely closed. The quantity of chemical product passing through each injector therefore depends on the time for which the corresponding injector is open. Accordingly, if the injector is opened at regular intervals, given that the pressure drop at the injector outlet is known, the flow rate of chemical product passing through the corresponding injector is known. The chemical product flow rate depends in particular on the viscosity of the chemical product, which in turn depends on the temperature and, of course, on the injector.

The injection line 18 terminates in two parallel branches each connecting the junction point 22 with the head loss line 20. Each of these branches includes an injector 48, 50. The injector 48 in a first branch is a conventional injector but the second injector 50 has a calibrated orifice enabling continuous calculation of the opening time of the product injectors so that the changing viscosity of the products to be sprayed can be taken into account.

Finally, a pressure sensor 52 on the injection line 18 continuously determines the pressure in the injection line 18.

As shown diagrammatically in the figure, the electronic unit 14 for managing the operation of the sprayer as a whole is connected to each of the injectors, the switch 28, the flowmeter 16 and the pressure sensor 52. Thus the sprayer described hereinabove uses the pressure drop generated by the pump 10 to inject the products to be mixed with water to obtain the solution to be sprayed. The technique employed means that no pump other than the main pump 10 need be used. It further avoids problems associated with the relatively high pressures generated by the pump 10, without compromising the safety inherent to the use of the phytosanitary products generally employed, i.e. no malfunction can pressurize the tanks or packaging containing the pure phytosanitary products. Also, the technique employed makes it a simple matter to automate rinsing the tanks or the phytosanitary product packaging and used rinsing water can be sprayed effectively and quickly onto the area that has been sprayed with the phytosanitary products.

The electronic module 14 incorporates a microprocessor for opening all the water and product injectors 36, 38, 40, 42 in turn or simultaneously to prepare an appropriate mixture. An algorithm permanently calibrates the injector opening time and self-tests correct operation of the injectors by analyzing the pressure that is established in the injection line 18 as a function of the opening of the injectors.

The electronic module 14 also includes an interface for communication with the user. A keypad and a display, not shown, can be provided for this purpose. The user can then program the quantity of product to be sprayed per hectare, for example. The user can also choose which products to add to the solution. It is also possible to choose to use a product over only a portion of the field to be treated.

The electronic module 14 can also contain an alarm system for alerting the user to a malfunction during spraying. Thus it is possible to signal that a tank is empty, an injector is faulty or there is a problem with the pump.

FIG. 2 shows a variant of the sprayer shown in FIG. 1. The modifications between the two embodiments shown in the drawings relate to the injection line 18 and the injectors. FIG. 2 uses the same reference numbers as FIG. 1 for similar components.

The main difference lies in the choice of three-port injectors 38′, 40′ and 42′ in place of the two-port injectors 38, 40 and 42. Because of this, the injectors 36, 48 and 50 can be dispensed with. The injectors 38′, 40′ and 42′ in FIG. 2 each have two inlets and one outlet. One inlet is connected to the outlet of the flowmeter 16 and the other inlet is connected to the corresponding chemical product “tank” 4 or 8 or to the rinsing device. The output of each injector 38′, 40′ and 42′ is connected to the junction point 22 of the injection line 18 with the head loss line 20. A nozzle is preferably provided at the outlet of each injector and at the chemical product or rinsing liquid inlet. This improves control of the flow rates of the chemical product and the carrier fluid.

In this embodiment, the injectors 38′, 40′ and 42′ pass either water from the tank 2 or chemical product (or rinsing product) from the tanks 4, 54 or 8. The injectors cannot assume a position in which the chemical product is mixed continuously with water. The outlet of these injectors is directly connected to one inlet or the other.

The rinsing device 6 is used to rinse the packaging 8 for the product to be sprayed and the secondary tank 4 before spraying and also for final rinsing of all the packaging and tanks when emptied of phytosanitary products at the end of spraying.

Both figures show how the rinsing device 6 is connected to the switch 28 and to the packaging 8. Of course, a connection that is not shown in the drawing, for reasons of clarity, is also established with the tank 4 for cleaning it.

A first rinsing of the tank 4 and the packaging 8 is performed by opening and closing the injectors 38, 40, 42 of the injection line 18. The relatively concentrated solution resulting from this first rinsing fills the tank 54 associated with the rinsing device 6 and is then sprayed onto the agricultural area, allowing for the possible concentration of the product so as not to cause an overdose.

When the rinsing tank 54 has been emptied, a rinsing valve 56 at the top of the tank enables the sprayer as a whole to be cleaned thoroughly.

The electronic module 14 controls the entire cleaning procedure and prompts the user as to the actions he must take. At the end of this procedure, the electronic module 14 advises the user that rinsing is finished via its communication interface.

Of course, the present invention is not limited to the embodiment described and shown, but encompasses any variant execution and/or combination of the various component parts thereof within the scope of the following claims.

For example, the number of injectors on the injection line can be varied. It is possible to connect to the injection line only tanks, into which the products to be sprayed are poured, or only the original packaging for the products to be sprayed. The coupling device provided between the product packaging and the corresponding injector is specified hereinabove by way of example and can be replaced by any other device for taking product from the packaging.

Using a device other than a check valve to create a pressure drop between the main tank and the pump can be envisaged. A calibrated throttle or a pump for obtaining the required pressure difference can also be used.

The embodiment described provides a sprayer manifold with two branches. It is of course possible to have a one-piece manifold or more than two branches. In the situation described of two branches, the switch includes a three-port valve, for example. If there are more branches, using an electric valve switch to choose the required branch can be envisaged. If it is not necessary to choose a branch, a simple check valve can be provided on each branch.

1. A sprayer device including a main tank (2) for a carrier product, at least one tank (4, 8) for a chemical product intended to be mixed with the carrier product, a sprayer manifold (12) or the like and a pump (10) downstream of the main tank (2) for feeding the carrier product under pressure from the main tank to the sprayer manifold or the like,
characterized in that means (34) are provided to create a calibrated pressure drop between the outlet of the main tank (2) for a carrier product and the inlet of the pump (10) and in that each tank (4, 8) for a chemical product is connected to an injection line (18) between the main tank (2) for a carrier product and the pump (10) by means (38, 42) enabling injection into that line of the chemical product in the corresponding chemical product tank.

2. A sprayer device according to claim 1, characterized in that the means for injecting the chemical product into the injection line have an outlet from which the pure chemical product exits intermittently.

3. A sprayer device according to either claim 1 or claim 2, characterized in that it includes a hydraulic network having two parallel branches (18, 20) between the main tank (2) for a carrier product and the pump (10), a first branch (20) incorporating the means (34) for creating the calibrated pressure drop and the second branch being the injection line (18).

4. A sprayer device according to claim 3, characterized in that the downstream end of the injection line (18) is connected to the downstream end of the first branch (20) by two injectors (48, 50) in parallel, one injector (50) having a calibrated orifice.

5. A sprayer device according to either claim 1 or claim 2, characterized in that it includes a hydraulic network having two parallel branches (18, 20) between the main tank (2) for a carrier product and the pump (10), the first branch (20) incorporates the means (34) for creating the calibrated pressure drop, the means for injecting the chemical product each take the form of a valve with two inlets and one outlet, one inlet of each valve is connected to the upstream point of the second branch (18), the second inlet of each valve is connected to a corresponding tank for a chemical product, the outlet of each valve is connected to the downstream point of the second branch (18), and the valve passes either the carrier fluid or the chemical product without mixing those products.

6. A sprayer device according to any of claims 1 to 5, characterized in that it includes an integral rinsing device (6) including a rinsing tank (56) provided with a rinsing valve (56) and connected downstream of the pump (10), between it and the sprayer manifold (12), on the one hand, to each tank (4, 8) for a chemical product and, on the other hand, to the injection line (18) via an injector (40).

7. A sprayer device according to any of claims 1 to 6, characterized in that at least one static homogenizer (32) is provided downstream of the pump (10).

8. A sprayer device according to any of claims 1 to 7, characterized in that a flowmeter (16) is provided at the outlet of the main tank (2).

9. A sprayer device according to any of claims 1 to 8, characterized in that it includes a pressure regulator device (24) downstream of the pump (10) and a return pipe (26) connects the pressure regulator device to a point upstream of the pump (10) and downstream of the injection line (18).

10. A sprayer device according to any of claims 1 to 9, characterized in that the injection line (18) is inclined to the horizontal.

11. A sprayer device according to any of claims 1 to 10, characterized in that the means (38, 40, 42) for injecting chemical product into the injection line and any sensors (16, 52) and valves (28) are connected to an electronic module (14) which controls the opening and closing of the injector means and any valves as a function of information received, on the one hand, by any sensors and, on the other hand, by a user.
